(19) United States
(12) Patent Application Publication
(10) Pub. No.: US 2014/0224628 A1
(43) Pub. Date: Aug. 14, 2014

(54) ELECTRIC CONTACT AND FABRICATION METHOD THEREOF

(71) Applicants: Jianhua Zhong, Guangzhou Science City (CN); Wenying Zhang, Guangzhou Science City (CN)

(72) Inventors: Jianhua Zhong, Guangzhou Science City (CN); Wenying Zhang, Guangzhou Science City (CN)

(73) Assignee: GUANGZHOU DEPOSON ELECTRIC TECHNOLOGY CO., LTD., Guangzhou Science City (CN)

(21) Appl. No.: 14/235,645

(22) PCT Filed: Jan. 5, 2012
(86) PCT No.: PCT/CN2012/070044

§ 371 Date: Apr. 10, 2014

(30) Foreign Application Priority Data
Jul. 29, 2011 (CN) 201110217642.3

(51) Int. Cl. H01H 1/06; H01H 11/04

(52) U.S. Cl. CPC H01H 1/06; H01H 11/04
USPC 200/270; 427/122

(57) ABSTRACT

The present invention discloses an electric contact, comprising a substrate with the surface thereof coated with a nano-diamond film heavily doped with positive trivalent or positive pentavalent elements; the present invention discloses a fabrication method of the above electric contact, comprising the following steps of: (1) fabricating a substrate of the electric contact; (2) performing auxiliary nucleation processing on the electric contact substrate; (3) depositing a nano-diamond film heavily doped with positive trivalent or positive pentavalent elements on the surface of the electric contact substrate. The present invention applies a heavily doped nano-diamond film in an electric contact such that the electric contact has super high heat conductivity, super high frictional wear resistance, high electrical conductivity, high breakdown voltage, high arc ablation resistance and fusion welding resistance, and at the same time, further has an advantage of simple processes, which greatly reduces production cost.

### FIELD OF THE INVENTION

The present invention relates to an electric contact and in particular, to an electric contact that is highly arc ablation-resistant and a fabrication method thereof.

### DESCRIPTION OF THE PRIOR ART

Electric contacts are contact elements for electric equipment, electric switches and instruments, which play a primary role in connecting and disconnecting electric circuits and carrying current; their performance primarily affects reliability and service life of electric equipment, electric switches and instruments. Over recent years, accidents have frequently occurred in China's power systems. With on-load tapping changing switch as an example, its equipment failure rate reaches 15%-30%, which significantly affects the safety of power transmission and transformation and obstructs the national economy and production. To a great extent, these problems are caused by low quality of electric contacts. Along with the rapid development of modernization construction, the load on high-voltage power transmission and transformation networks is increasingly high, which has posed higher requirements on the arc ablation-resistant capability of contact materials.

Currently, contact materials studied domestically and internationally are mostly (1) copper-tungsten materials prepared by means of powder metallurgy, (2) metal-based materials prepared by means of powder metallurgy and added with arc ablation-resistant diamond particles and (3) carbon composite metal materials prepared by means of vapor deposition or liquid deposition, specifically as follows:

(1) Copper-tungsten materials

According to the Chinese Patent 200810017440.2, CeO₂, a rare earth metal oxide with relatively low electron work function, is added into a copper-tungsten material, which disperses arc movement and reduces the concentrated ablation of arc on the contact material. Similarly, the Chinese Patent 200810018223.5 has disclosed the addition of a simple substance of rare earth lanthanum or cerium, nickel powder into a copper-tungsten material to improve the arc ablation-resistant capability. These copper-tungsten materials have the advantage of reduced arc ablation to certain degree. In an arcing state, copper that has a low melting point is melted and due to the capillary action, is adsorbed into the capillary pores of the tungsten skeleton that has a high melting point. Even when the local temperature is very high, the material will not result in fusion welding or splashing. At the same time, the melted copper absorbs a significant amount of heat due to phase change, which consequently lowers the material surface temperature. However, the drawbacks of this type of electric contact materials are also prominent. Other elements added for the purpose of further improving fusion resistance according to the above patented technologies often result in overly high electrical resistivity of contacts, consequently leading to increased resistance such that the contact temperature increase is too high to meet the requirements of relevant standards. At the same time, there are drawbacks like weak bonding force between this type of materials and the copper substrate and complicated welding process.

(2) Copper or silver-based materials added with arc ablation-resistant diamond particles

Diamond is a substance with the highest heat conductivity in the nature with the heat conductivity up to 138.16 Wm⁻¹K⁻¹. It has a high melting point (about 3700° C.), is resistant to abrasion, and at the same time, is the hardest substance in the world. The addition of a trace amount of fine diamond particles into a metal substrate by means of powder metallurgy can play a role in enhancing dispersion, and moreover, can provide advantages such as improved hardness and abrasion resistance, lowered surface temperature due to the excellent heat conductivity, and capability to resist fusion welding and electric ablation. For example, electric contact materials may be prepared by one or a combination of several of the addition of various simple substances of rare earth elements or oxides thereof into the copper-based materials added with diamond particles (Chinese Patent Nos. 200610046594.5, 01127933.8, 200410155250.9, 200610046594.5, 200610115204.5, 200510010555.5 and 200710045008.X), the addition of other metal oxides (Chinese Patent Nos. 03143970.5, 94102452.0 and 200710071995.0) and the improvement of powder metallurgy processes (Chinese Patent No. 201010207589.4). For example, furthermore, electric contact materials may also be prepared by a combination of diamond particles and/or other substances in silver-based materials (e.g. Chinese Patent Nos. 200810017203.6, 200310107771.2 and 200910196281.1). However, this type of technical solutions has several problems as follows: first, this type of electric contact materials tends to melt and adhere under the action of high voltage and high current such that serious ablation pits are formed on the contact surface, leading to premature failure, which cannot meet the demand of high load, particularly in the on load circumstance. Secondly, these electric contact materials are prepared with conventional powder metallurgy methods, i.e. metal powder, diamond powder and other additive powder are first mixed by means of mechanical powder mixing, which are then sequentially subjected to isostatic pressing, sintering in vacuum or a special atmosphere, extrusion forming, and lastly mechanical shaping. The diamond particles are often not distributed uniformly in the metal substrate after mechanical mixing, and the capability to consolidate diamond is weakened, which further impacts fusion welding resistance and arc ablation resistance of the electric contact. In addition, this type of materials tends to develop ingredient segregation, i.e. in the sintered copper alloy, the added rare earth elements or oxides thereof may still exist as simple substances. This is because it is difficult for rare earth elements to completely form alloys with a metal substrate; in addition, the electrical resistivity of electric contacts will also be affected. Therefore, the comprehensive electrical performance of the electric contact materials according to said technical solutions is not good.

(3) Metal-based materials with addition of carbon grains (including diamond)

The U.S. Pat. No. 7,709,759, European Patent Application No. EP1934995A1 and Japanese Patent Application No. JP2009-501420A use electric contact materials synthesized with diamond-like nano particles and metals (Group III to Group XII) or metal alloys. These materials are prepared with vapor deposition or liquid deposition methods and have advantages of low contact resistance, low friction coefficients, and relatively high resistance to ablation. Since this type of electric contacts is fabricated with diamond-like nano particles with the sp₂/sp₃ ratio higher than 0.6, i.e. the graphite phase is far greater than the diamond phase, however, the particles have low hardness, which greatly weakens the overall mechanical performance, in particular the frictional wear performance, of the electric contacts. The abrasion resistance and fusion welding resistance of the electric contact materials would be significantly weakened after a long period of use and the connection and breaking life is short.

### SUMMARY OF THE INVENTION

To overcome the drawbacks of the prior art, the object of the present invention is to provide an electric contact that is highly arc ablation-resistant.

The other object of the present invention is to provide a fabrication method of the above electric contact.

The objects of the present invention are attained through the following technical solution: an electric contact, comprising a substrate with the surface thereof coated with a nano-diamond film heavily doped with positive trivalent or positive pentavalent elements.

Said nano-diamond film is a nano-diamond film heavily doped with boron.

The molar ratio of boron to carbon in said nano-diamond film heavily doped with boron is greater than or equal to 0.01.

A method for fabricating the electric contact, comprising the following steps of:

(1) Fabricating a substrate of the electric contact;

(2) Performing auxiliary nucleation processing on the electric contact substrate;

(3) Depositing a nano-diamond film heavily doped with positive trivalent or positive pentavalent elements on the surface of the electric contact substrate to obtain an electric contact coated with the nano-diamond film.

Said Step (3) is specifically: depositing a nano-diamond film heavily doped with boron on the surface of the substrate to obtain an electric contact coated with the nano-diamond film heavily doped with boron.

Said deposition of a nano-diamond film heavily doped with boron on the surface of the substrate is specifically:

(3-1) Placing the electric contact substrate on the sample stage of a hot-filament chemical vapor deposition device; fully mixing the reaction gas, wherein in the reaction gas, the volume content of methane is 0.5˜5%, the volume content of trimethyl borate is 1˜4%, and the remaining is hydrogen;

(3-2) Setting up parameters of the hot-filament chemical vapor deposition device: the reaction pressure is 3˜8 KPar; the hot-filament temperature is 1500˜2800° C.; the underlay temperature is 500˜900° C., the hot-filament bias voltage is 10˜50 V, the bias voltage of bias pole is 0˜100 V, and the bias voltage of the sample stage is 0˜400 V; said bias pole is disposed right above the hot filament;

(3-3) Introducing the reaction gas into the deposition chamber of the hot-filament chemical vapor deposition device, and the deposition time is 1˜20 h.

Said Step (2) of performing auxiliary nucleation processing on the electric contact substrate is specifically: placing the electric contact substrate into a diamond micro powder solution with an organic solvent as the solvent, and subjecting it to ultrasonic vibration for 10˜60 min;

Alternatively: using a diamond micro powder solution with an organic solvent as the solvent to grind the electric contact substrate for 1˜20 min.

The substrate surface is further subjected to pretreatment after Step (1) and before Step (2); said pretreatment includes fine processing, surface enhancement, and transitional coating processing.

After Step (3) is carried out, dehydrogenation is further performed, which is specifically: placing the electric contact coated with the nano-diamond film obtained in Step (3) in a 3˜8 kPar oxygen atmosphere, heating to 100˜300° C., and keeping it constant for 5 min˜60 min.

Said reaction gas further comprises a nucleation assisting gas; the volume content of said nucleation assisting gas is 30%˜90%; said nucleation assisting gas is one of Ar, N₂, O₂, H₂O and CO₂ or any combination thereof.

Compared with the prior art, the present invention has the following advantages and technical effects:

According to the present invention, the nano-diamond film is heavily doped with positive trivalent or positive pentavalent elements, such that the diamond film has improved electrical conductivity, develops metal-like properties, and at the same time, preserves the diamond's own properties of super high heat conductivity, super high abrasion resistance and high melting point. The application of said film on an electric contact addresses the problems of the prior art such as weak ability to consolidate diamond onto substrate and poor mechanical performance, and moreover, results in the following excellent performance of the electric contact according to the present invention:

1. Super high heat conductivity: pure diamond has the highest heat conductivity among known natural materials with the coefficient of heat conductivity at 138.16 Wm⁻¹K⁻¹, which is five times of that of pure copper;

2. Super high frictional wear resistance: pure diamond is the hardest material among known natural materials, nano-diamond films have smooth surfaces and low friction coefficients (<0.1), therefore possessing excellent frictional wear resistance;

3. High electrical conductivity: when diamond is heavily doped, its electrical conductivity will be improved and develops metal-like properties with the electrical resistivity at about 10⁻² ωcm;

4. High breakdown voltage: the breakdown voltage is 250 kV/2.5 mm;

5. High arc ablation resistance and fusion welding resistance: since diamond has a high melting point (about 3700° C.), the electric contact according to the present invention possesses excellent arc ablation resistance and fusion welding resistance.

Thanks to the low requirements on geometric shape and size of substrate materials, meanwhile, the electric contact substrate according to the present invention may employ conventional electric contact materials and processing techniques, leading to simple processes and greatly reduced production cost.

### BRIEF DESCRIPTION OF THE DRAWINGS

FIG. 1 illustrates the hot-filament chemical vapor deposition device used in the first embodiment of the present invention.

FIG. 2 is a flow chart of the fabrication method in the first embodiment of the present invention.

FIG. 3 illustrates the electric contact in the first embodiment of the present invention, wherein the bold line portion indicates the surface deposited with nano diamond.

FIG. 4 is a surface SEM image of the nano-diamond film fabricated in the first embodiment of the present invention.

FIG. 5 is a cross sectional SEM image of the nano-diamond film fabricated in the first embodiment of the present invention.

FIG. 6 is a comparison of burning curves of the electric contact fabricated in the first embodiment of the present invention vs. conventional red copper and copper-tungsten electric contacts; wherein [symbol] indicates a red copper contact, [symbol] indicates a copper-tungsten alloy contact, and [symbol] indicates the electric contact of the present invention.

FIG. 7 illustrates the electric contact in the second embodiment of the present invention, wherein the bold line portion indicates the surface deposited with nano diamond.

FIG. 8 illustrates the electric contact in the third embodiment of the present invention, wherein the bold line portion indicates the surface deposited with nano diamond.

### DETAILED DESCRIPTION OF SPECIFIC EMBODIMENTS

The present invention will be further described in detail with reference to embodiments and accompanying drawings; however, embodiments of the present invention are not limited thereby.

### EXAMPLE 1

In this example, a hot-filament chemical vapor deposition device is used to fabricate the nano-diamond film. As shown in FIG. 1, the hot-filament chemical vapor deposition device comprises a deposition chamber 8, a sample stage 7, a hot filament 6 and a bias pole 5; the deposition chamber 8 is provided with a gas inlet 3 on the top and a gas outlet 9 at the bottom; said sample stage 7 is disposed underneath the deposition chamber 8, said hot filament 6 is disposed right above said sample stage 7, and said bias pole 5 is disposed right above said hot filament 6; a DC power supply 2 is connected between said bias pole 5 and ground to apply a bias voltage on the bias pole 5; a DC power supply 1 is connected between said hot filament 6 and ground to apply a DC bias voltage on the hot filament 6; a DC power supply 3 is connected between said sample stage 7 and ground to apply a DC bias voltage on the sample stage 7.

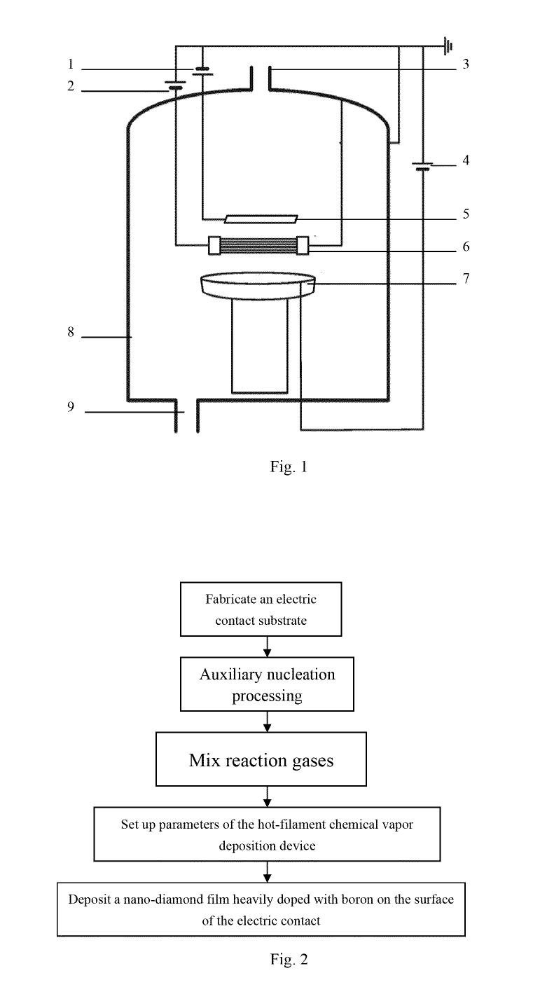

As shown in FIG. 2, the method for fabricating the electric contact in this example is as follows:

(1) Fabricating a substrate of the electric contact: in this example, copper (or copper alloy) is used as the substrate material, and the substrate of the electric contact is fabricated with a casting method.

(2) Performing auxiliary nucleation processing on the electric contact substrate;

(2-1) Washing the substrate with a solution of hydrochloric acid and nitric acid (with the volume ratio at HCl:HNO₃=1:1) assisted with heating and ultrasonic vibration;

(2-2) Placing the electric contact substrate into a diamond micro powder solution with methanol as the solvent, and subjecting it to ultrasonic vibration for 10 min;

(2-3) Placing in acetone and methanol sequentially for ultrasonic cleaning for 3 min, and blowing dry with compressed air.

(3) Depositing a nano-diamond film heavily doped with boron on the surface of the electric contact substrate to obtain an electric contact coated with the nano-diamond film, comprising the specific steps of:

(3-1) Placing the electric contact substrate on the sample stage of the hot-filament chemical vapor deposition device; fully mixing the reaction gas, wherein in the reaction gas, the volume content of methane (carbon source gas) is 0.5%, the volume content of trimethyl borate (doping gas) is 4%, the volume content of helium (nucleation assisting gas) is 30%, and the remaining is hydrogen (carrying gas);

(3-2) Setting up parameters of the hot-filament chemical vapor deposition device: the reaction pressure is 3 KPar; the hot-filament temperature is 1500° C.; the underlay temperature is 500° C., the hot-filament bias voltage is 10 V, no bias voltage is applied on the bias pole, and no bias voltage is applied on the sample stage;

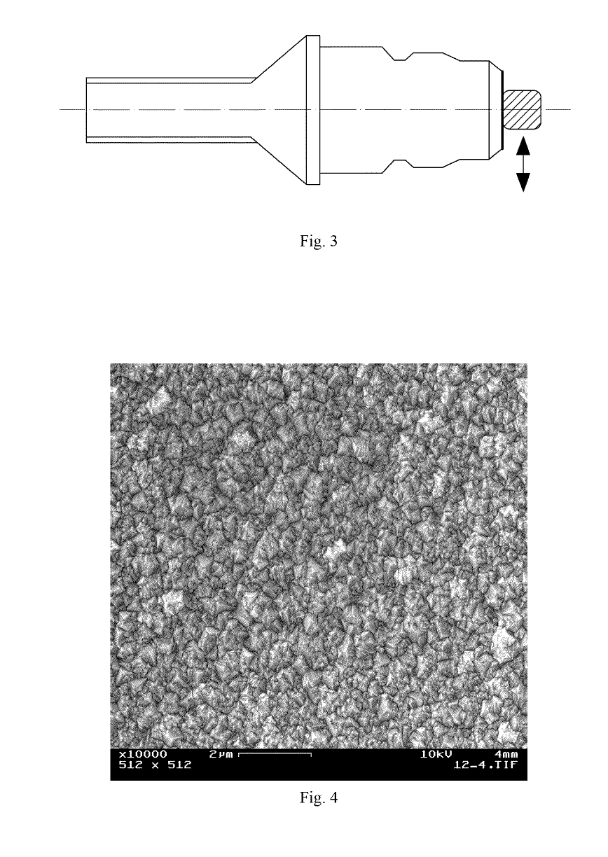

(3-3) Introducing the mixed gas into the deposition chamber of the hot-filament chemical vapor deposition device, and the deposition time is 5 h to obtain a 4 μm thick nano-diamond film heavily doped with boron (the molar ratio of carbon to boron is 0.01). The shape of the electric contact is shown in FIG. 3.

The surface morphology of the electric contact obtained in this example is shown in FIG. 4. It can be seen from FIG. 4 that the crystal grain size is 250˜400 nm, the grains are uniform, and the quality of the formed film is high.

The cross-sectional morphology of the electric contact obtained in this example is shown in FIG. 5. It can be seen from FIG. 5 that the crystal grains grow upwardly after nucleation on the substrate, a dense structure is formed among the crystal grains, and the uniformity is good.

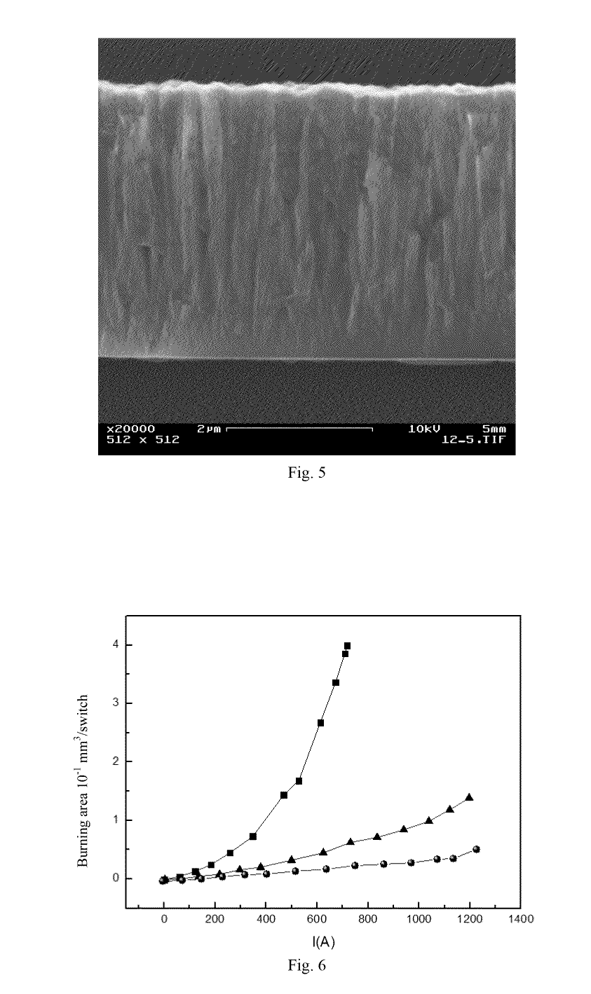

FIG. 6 is a comparison of burning curves of the electric contact fabricated in this embodiment vs. conventional red copper and copper-tungsten electric contacts. It can be seen from FIG. 6 that when a boron-doped nano-diamond film is deposited on the copper substrate material, the burning area per switching is greatly reduced relative to the contact of copper substrate material or of copper-tungsten alloy. The contact life is significantly extended.

### EXAMPLE 2

The method for fabricating the electric contact in this example is as follows:

(1) Fabricating the substrate of the electric contact: in this example, silver (or silver alloy) is used as the substrate material, and the substrate of the electric contact is fabricated with a pressing method.

(2) Performing auxiliary nucleation processing on the electric contact substrate;

(2-1) First, washing the substrate with a solution of hydrochloric acid and nitric acid (with the volume ratio at HCl:HNO₃=1:1) assisted with heating and ultrasonic vibration;

(2-2) Using a diamond micro powder solution with an organic solvent as the solvent to grind the substrate for 1 min;

(2-3) Placing in ethanol and formaldehyde sequentially for ultrasonic cleaning for 3 min, and blowing dry with compressed air.

(3) Depositing a nano-diamond film heavily doped with boron on the surface of the electric contact substrate to obtain an electric contact coated with the nano-diamond film, comprising the specific steps of:

(3-1) Placing the electric contact substrate on the sample stage of the hot-filament chemical vapor deposition device; fully mixing the reaction gas, wherein in the reaction gas, the volume content of methane (carbon source gas) is 5%, the volume content of trimethyl borate (doping gas) is 1%, the volume content of helium (nucleation assisting gas) is 60%, and the remaining is hydrogen (carrying gas);

(3-2) Setting up parameters of the hot-filament chemical vapor deposition device: the reaction pressure is 8 KPar; the hot-filament temperature is 2800° C.; the underlay temperature is 900° C., the hot-filament bias voltage is 50 V, a 100 V bias voltage is applied on the bias pole, and a 400 V bias voltage is applied on the sample stage;

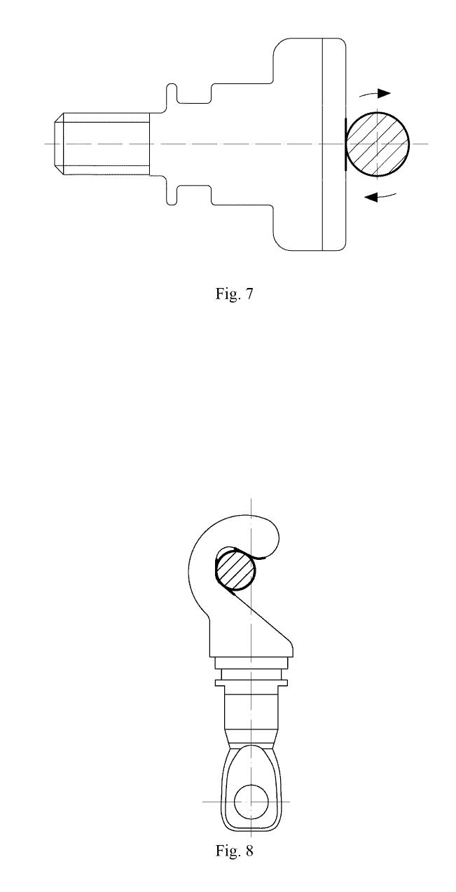

(3-3) Introducing the mixed gas into the deposition chamber of the hot-filament chemical vapor deposition device, and the deposition time is 20 h to obtain a 15 μm thick nano-diamond film heavily doped with boron (the molar ratio of carbon to boron is 0.1). The shape of the electric contact is shown in FIG. 7.

### EXAMPLE 3

The method for fabricating the electric contact in this example is as follows:

(1) Fabricating the substrate of the electric contact: in this example, gold (or gold alloy) is used as the substrate material, and the substrate of the electric contact is fabricated with a powder metallurgy method.

(2) Performing auxiliary nucleation processing on the electric contact substrate;

(2-1) First, washing the substrate with a solution of hydrochloric acid and nitric acid (with the volume ratio at HCl:HNO₃=1:1) assisted with heating and ultrasonic vibration;

(2-2) Placing the electric contact substrate into a diamond micro powder solution with methanol as the solvent, and subjecting it to ultrasonic vibration for 60 min;

(2-3) Placing in glycerin and ethanol sequentially for ultrasonic cleaning for 3 min, and blowing dry with compressed air.

(3) Depositing a nano-diamond film heavily doped with boron on the surface of the electric contact substrate to obtain an electric contact coated with the nano-diamond film, comprising the specific steps of:

(3-1) Placing the electric contact substrate on the sample stage of the hot-filament chemical vapor deposition device; fully mixing the reaction gas, wherein in the reaction gas, the volume content of methane (carbon source gas) is 2%, the volume content of trimethyl borate (doping gas) is 3%, the volume content of helium (nucleation assisting gas) is 90%, and the remaining is hydrogen (carrying gas);

(3-2) Setting up parameters of the hot-filament chemical vapor deposition device: the reaction pressure is 6 KPar; the hot-filament temperature is 2000° C.; the underlay temperature is 700° C., the hot-filament bias voltage is 30 V, a 50 V bias voltage is applied on the bias pole, and a 200 V bias voltage is applied on the sample stage;

(3-3) Introducing the mixed gas into the deposition chamber of the hot-filament chemical vapor deposition device, and the deposition time is 10 h to obtain a 8 μm thick nano-diamond film heavily doped with boron (the molar ratio of carbon to boron is 0.06). The shape of the electric contact is shown in FIG. 8.

### EXAMPLE 4

In this example, the substrate surface is further subjected to a pretreatment step after Step (1) and before Step (3), and the other steps are the same as those in Example 1.

Said pretreatment is fine processing, which may be one of scraping, smoothing, grinding, honing and polishing or any combination thereof; said polishing may be one of mechanical polishing, mechanical and chemical polishing, chemical polishing, and electrochemical polishing or any combination thereof.

### EXAMPLE 5

In this example, the substrate surface is further subjected to a pretreatment step after Step (1) and before Step (3), and the other steps are the same as those in Example 1.

Said pretreatment is surface enhancement, which may be mechanical surface enhancement or one of heat processing or surface chemical heat processing or a combination thereof; main methods of said surface heat processing include flame quenching and heat processing through induction heating, commonly used heat sources include flames such as oxyacetylene or oxypropane, induction current (electric spark), laser, electron beam, etc.; said surface chemical heat processing may be one of carburization, nitriding and metallic cementation or a combination thereof.

### EXAMPLE 6

In this example, the substrate surface is further subjected to a pretreatment step after Step (1) and before Step (3), and the other steps are the same as those in Example 1.

Said pretreatment is transitional layer processing, which deposits a transitional layer on the substrate surface; said transitional layer maybe metal (non-copper), metal alloy (non-copper alloy), metal oxide (non-copper oxide), metal carbide (non-copper carbide) or ceramics; the deposition process may be one of physical vapor deposition, chemical vapor deposition, liquid deposition, and spraying deposition or any combination thereof.

### EXAMPLE 7

In this example, a dehydrogenation step is further carried out after Step (3), and the other steps are the same as those in Example 1.

The dehydrogenation step is specifically: placing the electric contact obtained in Step (3) in a 3 kPar oxygen atmosphere, heating to 100° C., and keeping it constant for 5 min to remove the hydrogenation layer on the surface of the nano-diamond film as a result of the growing process such that the electric contact material possesses a constant super-high electrical conductivity.

### EXAMPLE 8

In this example, a dehydrogenation step is further carried out after Step (3), and the other steps are the same as those in Example 1.

The dehydrogenation step is specifically: placing the electric contact obtained in Step (3) in an 8 kPar oxygen atmosphere, heating to 300° C., and keeping it constant for 60 min to remove the hydrogenation layer on the surface of the nano-diamond film as a result of the growing process such that the electric contact material possesses a constant super-high conductive capability.

### EXAMPLE 9

In this example, a dehydrogenation step is further carried out after Step (3), and the other steps are the same as those in Example 1.

The dehydrogenation step is specifically: placing the electric contact obtained in Step (3) in a 5 kPar oxygen atmosphere, heating to 200° C., and keeping it constant for 40 min to remove the hydrogenation layer on the surface of the nano-diamond film as a result of the growing process such that the electric contact material possesses a constant super-high conductive capability.

The above examples are preferred embodiments of the present invention, however, embodiments of the present invention are not limited by those examples. For example, the method for depositing the nano-diamond film may be physical vapor deposition, liquid deposition, or other plating methods; the carbon source gas may be one of methanol, ethanol, acetone, acetylene, ethylene, methane and ethane or any combination thereof; the doping gas may be a gas containing other positive trivalent or positive pentavalent elements; the nucleation assisting gas may be one of Ar, N₂, O₂, H₂O and CO₂ or any combination thereof; the carrying gas may be an isotope gas of hydrogen, etc.; any other variation, modification, replacement, combination or simplification without departing from the spirit and principle of the present invention shall be equivalent substitution and encompassed by the scope of the present invention.

What is claimed is:

1. An electric contact, comprising a substrate, characterized in that the surface of said substrate is coated with a nano-diamond film heavily doped with positive trivalent or positive pentavalent elements.

2. The electric contact as set forth in claim 1, characterized in that said nano-diamond film is a nano-diamond film heavily doped with boron.

3. The electric contact as set forth in claim 2, characterized in that the molar ratio of boron to carbon in said nano-diamond film heavily doped with boron is 0.01˜0.1.

4. A method for fabricating the electric contact, characterized in that it comprises the following steps of:
(1) Fabricating a substrate of the electric contact;
(2) Performing auxiliary nucleation processing on the electric contact substrate;
(3) Depositing a nano-diamond film heavily doped with positive trivalent or positive pentavalent elements on the surface of the electric contact substrate to obtain an electric contact coated with the nano-diamond film.

5. The method for fabricating the electric contact as set forth in claim 4, characterized in that said Step (3) is specifically:
depositing a nano-diamond film heavily doped with boron on the surface of the substrate to obtain an electric contact coated with the nano-diamond film heavily doped with boron.

6. The method for fabricating the electric contact as set forth in claim 5, characterized in that said deposition of a nano-diamond film heavily doped with boron on the surface of the substrate is specifically:
(3-1) Placing the electric contact substrate on the sample stage of a hot-filament chemical vapor deposition device; fully mixing the reaction gas, wherein in the reaction gas, the volume content of methane is 0.5˜5%, the volume content of trimethyl borate is 1˜4%, and the remaining is hydrogen;
(3-2) Setting up parameters of the hot-filament chemical vapor deposition device: the reaction pressure is 3˜8 KPar; the hot-filament temperature is 1500˜2800° C.; the underlay temperature is 500˜900° C., the hot-filament bias voltage is 10˜50 V, the bias voltage of bias pole is 0˜100 V, and the bias voltage of the sample stage is 0˜400 V; said bias pole is disposed right above the hot filament;
(3-3) Introducing the reaction gas into the deposition chamber of the hot-filament chemical vapor deposition device, and the deposition time is 1˜20 h.

7. The method for fabricating the electric contact as set forth in claim 6, characterized in that said Step (2) of performing auxiliary nucleation processing on the electric contact substrate is specifically: placing the electric contact substrate into a diamond micro powder solution with an organic solvent as the solvent, and subjecting it to ultrasonic vibration for 10˜60 min;
Alternatively: using a diamond micro powder solution with an organic solvent as the solvent to grind the electric contact substrate for 1˜20 min.

8. The method for fabricating the electric contact as set forth in claim 4, characterized in that the substrate surface is further subjected to pretreatment after Step (1) and before Step (2); said pretreatment includes fine processing, surface enhancement, and transitional coating processing.

9. The method for fabricating the electric contact as set forth in claim 4, characterized in that after Step (3) is carried out, dehydrogenation is further performed, which is specifically: placing the electric contact coated with the nano-diamond film obtained in Step (3) in a 3˜8 kPar oxygen atmosphere, heating to 100˜300° C., and keeping it constant for 5 min˜60 min.

10. The method for fabricating the electric contact as set forth in claim 6, characterized in that said reaction gas further comprises a nucleation assisting gas with a volume content of 30%˜90%; said nucleation assisting gas is one of Ar, N₂, O₂, H₂O and CO₂ or any combination thereof.
